(19) United States
(12) Patent Application Publication
(10) Pub. No.: US 2004/0148180 A1
(43) Pub. Date: Jul. 29, 2004

(54) Facilitating job advancement

(75) Inventor: Dimple Mahesh Pajwani, Missouri City, TX (US)

Correspondence Address: Marilyn Smith Dawkins, Intellectual Property Law Dept., IBM Corporation, 11400 Burnet Road, Austin, TX, 78758, US

(73) Assignee: International Business Machines Corporation, Armonk, NY

(21) Appl. No.: 10/351,563

(22) Filed: Jan. 23, 2003

(51) Int. Cl. G06F 17/60

(52) U.S. Cl. 705/1

(57) ABSTRACT

A method, system, and program for facilitating job advancement are provided. A profile form is provided to a job seeker to enter current skills and goals for a sought for position. A job profile database is searched for a particular job position matching the current skills and goals. The job seeker is presented the particular job position matching the current skills and the goals, wherein the job seeker is also presented with at least one resource for acquiring at least one remaining skill required for the job seeker to qualify for the particular job position.

### BACKGROUND OF THE INVENTION

1. Technical Field

The present invention relates in general to job searching and, in particular, to computerized job searching engines. Still more particularly, the present invention relates to facilitating job advancement of job seeker through a job search engine.

2. Description of the Related Art

The internet is an amazing tool for job placement. Companies can post job listings accessible to unnumbered potential employees. Individuals can search company postings by job type, location, and other criteria and submit resumes electronically to future employers. Large job search engines combine the job postings for multiple employers. In addition, large job search engines may allow individuals to designate the type of job preferred and the search engine will provide updates to the individual each time a new posting matches the type of job preferred by the employee.

While current job search engines provide benefits to both individuals seeking jobs and businesses seeking employees, these search engines are limited because they focus on job placement rather than job advancement. Job search engines are limited in focus to the skills an employee must already have for a job, not providing individuals or current employees with information about how to obtain the skills needed for advancement to a job that meets the goals of the job seeker.

Individual companies may provide search engines for searching job postings for that company. These company job postings are limited, however, because they also focus on job placement rather than job advancement. It is often difficult for current employees to determine how to advance or move to a new group within a company. Further, many companies will reimburse employees for a set amount of continuing education each year, however, job postings do not indicate which types of continuing education would be advantageous for a current employee to be eligible to advance to a new position.

In view of the foregoing, it would be advantageous to provide a method, system, and program for searching job positions based on a job seeker's goals and then providing the job seeker with resources to obtain the skills needed to advance to a job meeting the job seeker's goals. Further, it would be advantageous to provide a method, system, and program for searching job positions based on skills a job seeker would like to acquire and then providing the job seeker with a selection of jobs for which the job seeker is qualified and which include training in the skills the job seeker would like to acquire.

### SUMMARY OF THE INVENTION

In view of the foregoing, it is therefore an object of the present invention to provide improved job searching.

It is another object of the present invention to provide a method, system and program for improved computerized job searching engines.

It is yet another object of the present invention to provide a method, system and program for facilitating job advancement of job seeker through a job search engine.

According to one aspect of the present invention, a profile form is provided to a job seeker to enter current skills and goals for a sought for position. A job profile database is searched for a particular job position matching the current skills and goals. The job seeker is presented the particular job position matching the current skills and the goals, wherein the job seeker is also presented with at least one resource for acquiring at least one remaining skill required for the job seeker to qualify for the particular job position.

According to another aspect of the present invention, a profile form is provided to a job seeker to enter current skills and at least one skill sought to be acquired in a job position. A job profile database is searched for a particular job position matching the current skills and at least one skill sought to be acquired. The job seeker is presented with the particular job position matching the current skills and at least one skill sought to be acquired, such that the job seeker is shown jobs in which the job seeker can acquire a desired skill as part of the training for the job.

Job seekers may include a current employee of a company whose job positions comprise the job profile database. A current employee may be allowed access to more information about job positions. For example, a company may only provide a diagram to current employees of the hierarchy of job positions showing the advancement path associated with a particular job position. In addition, a current employee may qualify for employer-sponsored resources for which a non-current employee would not qualify.

Resources may include, but are not limited to, an educational resource link, an available job link, a method for reimbursement link, and an organizational resource link. Preferably, an employer may track whether a job seeker takes advantage of resources. Goals may include, but are not limited to, a management goal, a certification goal, a salary goal, and an advancement path goal.

In addition, a profile form may be provided for an employer to enter at least one from among skill preferences and goal preferences to be found in a potential employee. A job criteria database is searched for at least one potential employee with job criteria matching a job profile of said employer. The employer is presented with at least one potential employee meeting the requirements of the job profile.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of one embodiment of a computer system with which the method, system and program of the present invention may advantageously be utilized;

FIG. 2 depicts a simplified block diagram of a client/server environment for facilitating job advancement searches in accordance with the method, system, and program of the present invention;

FIG. 3 depicts a block diagram of a job advancement search for determining skills required to acquire a job matching a job seeker's goals and providing information about resources available to acquire the required skills in accordance with the method, system, and program of the present invention;

FIG. 4 depicts a block diagram of a job advancement search for jobs providing training in the skills a job seeker wants to acquire in a new job in accordance with the method, system, and program of the present invention;

FIG. 5 depicts a block diagram of a job profile for an employer in accordance with the method, system, and program of the present invention;

FIG. 6 depicts a block diagram of an employment structure within a company in accordance with the method, system, and program of the present invention;

FIG. 7 depicts a block diagram illustrates a job criteria of a job seeker in accordance with the method, system, and program of the present invention;

FIG. 8 depicts an illustrative representation of the search results returned for display to a job seeker in accordance with the method, system, and program of the present invention;

FIG. 9 depicts a high level logic flowchart of a process and program for managing a job profile in accordance with the method, system, and program of the present invention;

FIG. 10 depicts a high level logic flowchart depicts a process and program for managing job criteria in accordance with the method, system, and program of the present invention; and

FIG. 11 depicts a high level logic flowchart of a process and program for managing resources available to job seekers in accordance with the method, system, and program of the present invention.

### DETAILED DESCRIPTION OF THE PREFERRED EMBODIMENT

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

The present invention may be executed in a variety of systems, including a variety of computing systems and electronic devices under a number of different operating systems. In one embodiment of the present invention, the computing system is a portable computing system such as a notebook computer, tablet computer, a palmtop computer, a personal digital assistant, a telephone or other electronic computing system that may also incorporate communications features that provide for telephony, enhanced telephony, messaging and information services. However, the computing system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

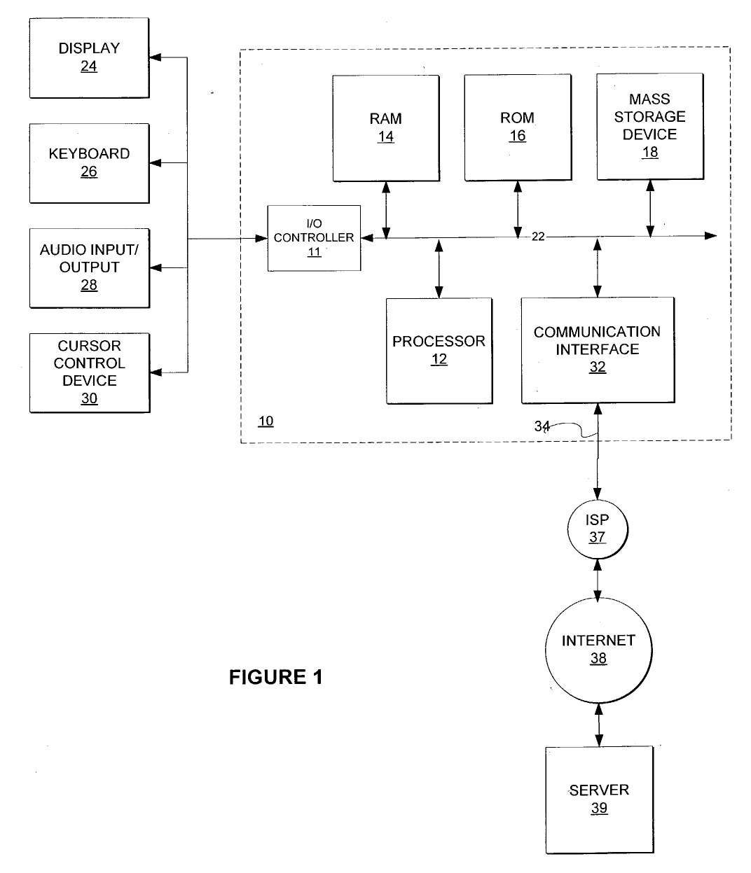

Referring now to the drawings and in particular to FIG. 1, a block diagram illustrates one embodiment of a computer system with which the method, system and program of the present invention may advantageously be utilized. Computer system 10 includes a bus 22 or other communication device for communicating information within computer system 10, and at least one processing device such as processor 12, coupled to bus 22 for processing information. Bus 22 preferably includes low-latency and higher latency paths that are connected by bridges and controlled within computer system 10 by multiple bus controllers.

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowchart of FIG. 14, and others described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of a non-volatile medium is mass storage device 18. Volatile media include dynamic memory such as RAM 14. Transmission media include coaxial cables, copper wire or fiber optics, including the wires that comprise bus 22. Transmission media can also take the form of acoustic or light waves, such as those generated during radio frequency or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10, connected to an input/output (I/O) controller 11 coupled to bus 22. For example, an audio input/output device 28 is attached to I/O controller 11 for controlling audio input through a microphone or other sound or lip motion capturing device and audio output through a speaker or other audio projection device. A display 24 is also attached to I/O controller 11 for providing visual, tactile or other graphical representation formats. A keyboard 26 and cursor control device 30, such as a mouse, trackball, or cursor direction keys, are coupled to I/O controller 11 as interfaces for user inputs to computer system 10. In alternate embodiments of the present invention, additional input and output peripheral components may be added.

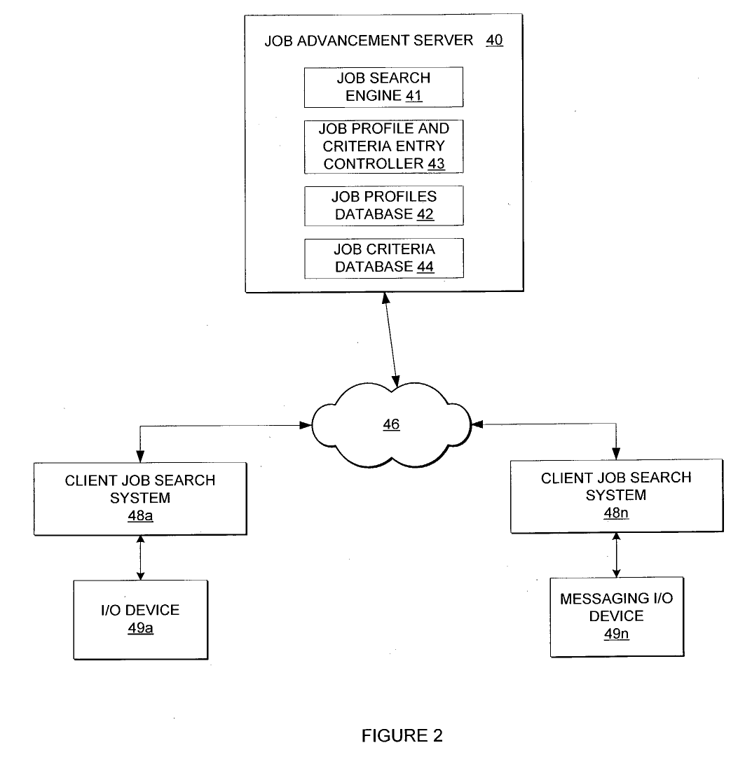

With reference now to FIG. 2, a simplified block diagram depicts a client/server environment for facilitating job advancement searches in accordance with the method, system, and program of the present invention. The client/server environment is implemented within many network architectures. For example, the architecture of the World Wide Web (the Web) follows a traditional client/server model environment.

The terms “client” and “server” are used to refer to a computer's general role as a requester of data (the client) or provider of data (the server). In the Web environment, web browsers such as Netscape Navigator typically reside on client job search systems 48a-48n and render Web documents (pages) served by at least one job advancement server such as job advancement server 40. Additionally, each of client job search systems 48a-48n and job advancement server 40 may function as both a “client” and a “server” and may be implemented utilizing a computer system such as computer system 10 of FIG. 1. Further, while the present invention is described with emphasis upon job advancement server 40 controlling a job search engine, the present invention may also be performed by client job search systems 48a-48n engaged in peer-to-peer network communications via a network 46. Further, it should be noted that client job search systems 48a-48n may include portable and handheld computing devices.

The Web may refer to the total set of interlinked hypertext documents residing on servers all around the world. Network 46, such as the Internet, provides an infrastructure for transmitting these hypertext documents between client job search systems 48a-48n and job advancement server 40. Documents (pages) on the Web may be written in multiple languages, such as Hypertext Markup Language (HTML) or Extensible Markup Language (XML), and identified by Uniform Resource Indicators (URIs) that specify the particular job advancement server 40 and pathname by which a file can be accessed, and then transmitted from job advancement server 40 to an end user utilizing a protocol such as Hypertext Transfer Protocol (HTTP). Web pages may further include text, graphic images, movie files, and sounds, as well as Java applets and other small embedded software programs that execute when the user activates them by clicking on a link. While network 46 is described with reference to the Internet, network 46 may also operate within an intranet or other available networks.

A job seeker enters job criteria via one of I/O devices 49a-49n for storage in a job criteria database 44 of job advancement server 40. In addition, an employer enters a job profile via one of I/O devices 49a-49n for storage in a job profiles database 42 within job advancement server 40. In particular, job profile and criteria entry controller 43 provides templates for entry of job profiles and job criteria when requested by any of client job search systems 48a-48n. For purposes of the present invention, a job seeker includes those individuals with no current job seeking a job, those individuals currently with a job who are actively seeking a new job, and those individuals currently with a job who are passively seeking a new job by determining what skills the individual needs to acquire to seek a job meeting the individual's goals.

A job seeker may also enter a request via one of I/O devices 49a-49n to receive a selection of potential jobs. Alternatively, job search engine 41 may trigger a search for a selection of potential jobs at set intervals or in response to a new job profile added, and send the selection of potential jobs to the job seeker via a communication device accessible to the job seeker.

Job search engine 41 determines a selection of potential jobs by comparing the job profiles in job profiles database with that job seeker's criteria stored in job criteria database 44. Job search engine then returns a search result indicating three categories of jobs. The first category is jobs for which the job seeker has the required skills. The second category is jobs which will require the job seeker to learn skills that the job seeker wants to acquire in a new job. The third category is jobs which meet a job seeker's goals, but which may require skills the job seeker does not currently have. In addition, the third category includes resources for the job seeker to acquire these required skills.

In addition, an employer may enter a request via one of I/O devices 49a-49n to receive a selection of potential employees. Alternatively job search engine 41 may trigger a search for a selection of potential employees at set intervals or in response to new job criteria added, and send the selection of potential employees to the employer via a communication device accessible to the employer.

Job search engine 41 determines a selection of potential employees for a particular job profile by comparing the job criteria for multiple job seekers with the employer's job profile stored in job profiles database 42. The first category is potential employees whose skills meet the requirements of the job profile. The second category is potential employees who want to learn the skills that will be acquired by the person employed for the job. The third category is potential employees who have taken advantage of the resources available to acquire the skills needed for the job profile.

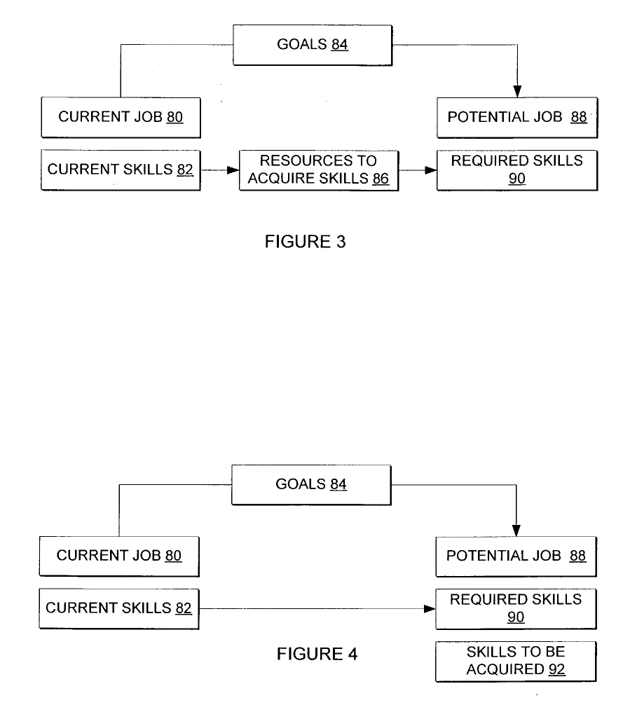

Referring now to FIG. 3, a block diagram illustrates a job advancement search for determining skills required to acquire a job matching a job seeker's goals and providing information about resources available to acquire the required skills in accordance with the method, system, and program of the present invention. As depicted, a job seeker wants to move from a current job 80 (which may include no job) to a potential job 88. The job seeker has goals 84 that categorize potential job 88 as a job into which the job seeker would like to transition.

To be considered for potential job 88 there are required skills 90. It is assumed, for the example, that the job seeker's current skills 82 do not meet all of required skills 90. Thus, there are skills the job seeker will have to acquire to be qualified to apply for potential job 88.

In providing the job seeker information about potential job 88, the job seeker will also be provided with resources to acquire the remaining required skills 86. These resources may include any number of types of educational, business, social, and practical resources. For example, a resource may include contact information for educational programs providing courses and certifications that if completed would meet the requirements for the remaining required skills. In addition, the resources may include information about the employer sponsoring of current employee education. Further, the resources may include information about individuals and organizations who provide training that if completed would meet the requirements for the remaining required skills. Moreover, the resource may include a list of employers who provide the types of internships and other entry-level experience required to acquire the remaining required skills. Governmental licensing requirements and materials available to complete these requirements may also be included as resources.

With reference now to FIG. 4, a block diagram depicts a job advancement search for jobs providing training in the skills a job seeker wants to acquire in a new job in accordance with the method, system, and program of the present invention. As described in FIG. 3, a job seeker wants to move from a current job 80 to a potential job 88. In this example, however, the job seeker wants to acquire new skills from a new job. Thus, potential job 88 includes the skills to be acquired 92 matching those skills the job seeker selected to attain from a new job. It will be understood that potential job 88 may include skills to be acquired 92 matching those skills the job seeker selected to attain from a new job and yet the job seeker may still have to acquire required skills 90 to qualify for the position.

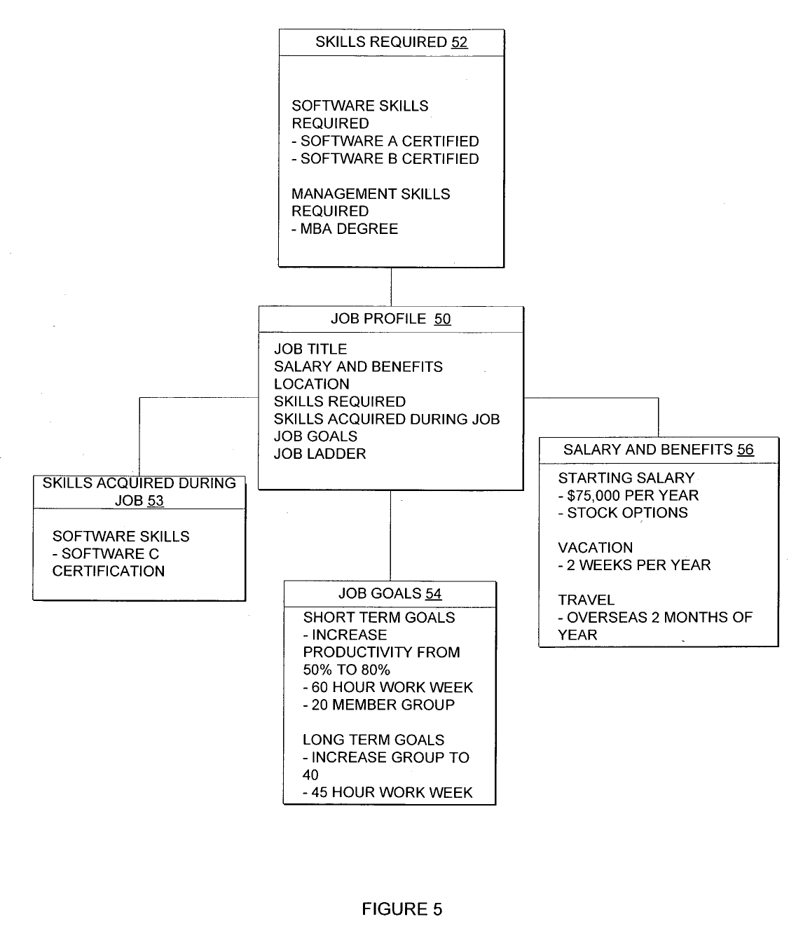

Referring now to FIG. 5, a block diagram illustrates a job profile for an employer in accordance with the method, system, and program of the present invention. As depicted, a job profile 50 may include multiple fields of information. In the example, job profile 50 includes a job title, salary and benefits, location, skills required, skills acquired during the job, job goals and a job ladder. It will be understood that other fields of job profile data may be specified. Further, it will be understood that the specific job profile information depicted in this example is merely for purpose of illustration and does not limit the type of information that may be entered for a job profile.

There are some skills an employer plans for employees to learn during training for a position and other skills the employer requires an employee to already have to qualify for a position. A skills required field 52 indicates skills the employer requires an employee to already have to qualify for a position. A skills acquired during the job field 53 indicates skills that will be acquired as part the training for a position once hired.

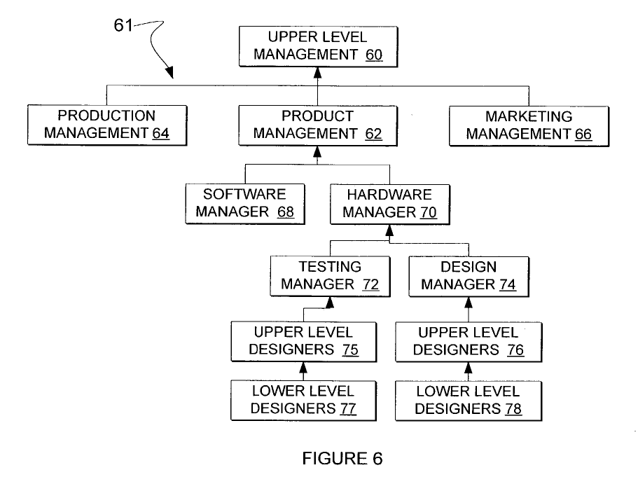

A skills required field 52 includes information about the software and management skills required for the position. As will be described in further detail in FIG. 6, the example depicted is a testing manager level position requiring certification in software A and software B and a here.

A skills acquired during the job field 53 indicates the software skills that will be acquired through on-the-job training. In particular, certification in software C is part of the training provided for the job.

An employer often sets the goals for expansion of a position. In the example, job goals field 54 indicates the short term and long term goals of an employer for the position. For example, productivity rates, reducing hours in a work week and increasing the size of group below a position may be factors for goals of a position.

Salary and benefits are often an important factor in a job seeker's decision to look at other jobs. Salary and benefits field 56 indicates the starting salary, vacation time, and travel for the job. If available, an employer may include information about the past rate for salary increases in the position and other information about salary and benefits.

With reference now to FIG. 6, a block diagram illustrates an employment structure within a company in accordance with the method, system, and program of the present invention. An employment structure 61 includes an example of the multiple levels of employment within a company. An employer may include employment structure 61 or some other structural diagram indicating the job ladder to reach a particular position. Provision of employment structure 61 is most feasible within a company intranet job advancement system available only for viewing by current employees with secured access to portions of the employment structure.

In the example, the hierarchy of positions indicates the titles associated with each level of the hierarchy. Preferably, if employment structure 61 is displayed to a user, additional information such as the expectations, skills required, salary, hours, location and other characteristics of each level are also provided. Further, distinguishing characteristics of multiple positions within one level of the hierarchy are identified.

In the example, the top level is upper level management 60. Three divisions follow upper level management 60—production management 64, product management 62, and marketing management 66. Under product management 62, there are two additional divisions—software manager 68 and hardware manager 70. Further, under the hardware manager, there are two divisions—testing manager 72 and design manager 74. Below each of these divisions are upper level designers 75 and 76 and lower level designers 77 and 78. In the example following, an employee currently working in lower level designers 78 wants to advance in position.

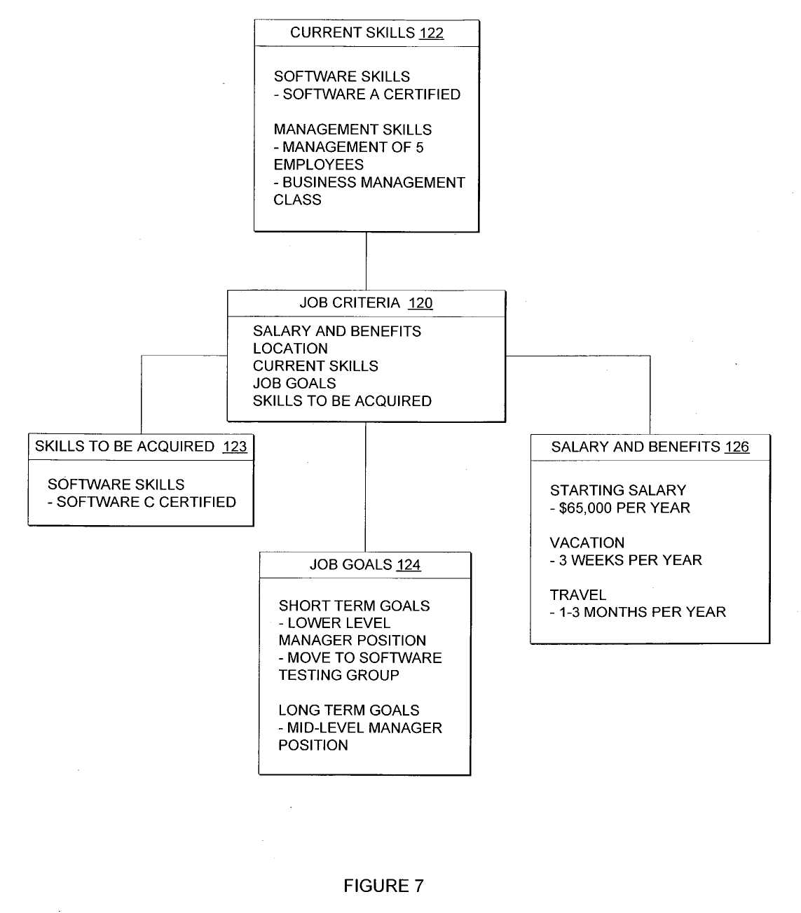

Referring now to FIG. 7, a block diagram illustrates a job criteria of a job seeker in accordance with the method, system, and program of the present invention. As depicted, a job criteria 120 may include multiple fields of information. In the example, job criteria 120 includes salary and benefits, location, current skills, job goals, and skills to be acquired during the job. It will be understood that other fields of job criteria data may be specified. Further, it will be understood that the specific job criteria information depicted in this example is merely for purpose of illustration and does not limit the type of information that may be entered for a job criteria.

As illustrated, a salary and benefits field 126 includes the starting salary, vacation, and travel preferences of a job seeker. A job seeker may indicate a maximum, minimum, or range of an acceptable salary, vacation, and travel. In addition, a job seeker may specify other types of preferred benefits and compensation.

In looking for a new job, a job seeker may hope to take current skills that are underutilized in a current position and apply them to a new position with additional compensation or a different work environment. Current skills field 122 indicates the current skills a job seeker possesses. In the example, the job seeker has software and management skills. It will be understood that other types of skills may be specified by a job seeker.

In addition, in looking for a new job, a job seeker may have goals the job seeker would like to accomplish in a new job. A typical resume includes a one sentence objective. This one sentence objective does not allow a job seeker to specify short term and long term goals to determine if a job position will act as a platform for these short term and long term goals. If a job seekers is not completely qualified for the positions meeting job goals 124, according to an advantage of the present invention, the job seeker is provided with resources to acquire the skills need to become qualified for the positions meeting job goals 124.

Further, in looking for a new job, a job seeker may hope to acquire certain skills during the required training and implementation of a new job. For example, skills to be acquired field 123 indicates the job seeker hopes to acquire the software C certification as part of the training for a new position. In particular, where skills are identified that a job seeker will need to acquire to attain a job meeting the job seeker's goals, the job seeker may request those skills be added to skills to be acquired field 123.

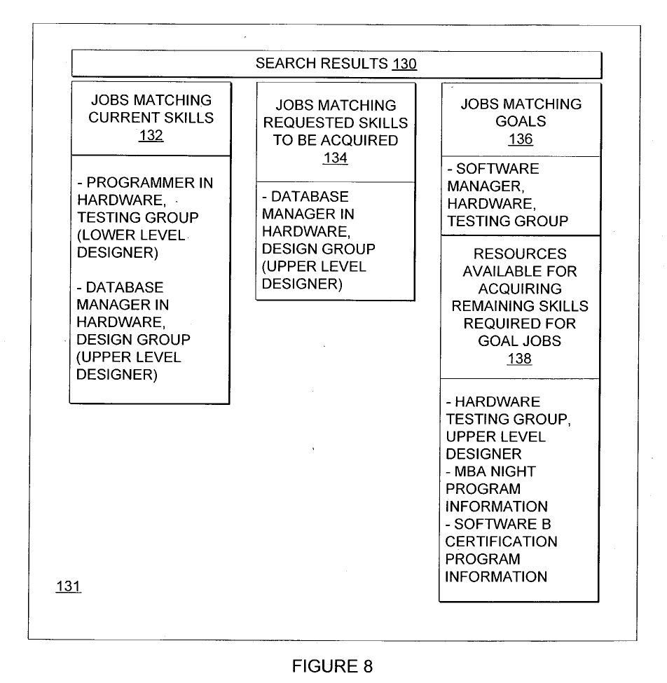

With reference now to FIG. 8, an illustrative representation shows the search results returned for display to a job seeker in accordance with the method, system, and program of the present invention. As illustrated, an interface 131 displays search results 130. The search results include three categories of job positions. The job positions displayed indicate the title of the position, the group within the hierarchy and the level of the position within the hierarchy. The job seeker preferably obtains additional information about the job position by selecting the job position by selecting a particular job position out of those displayed. In addition, additional information about each job positions may be displayed within interface 131. Further, a user may request a comparison of the job positions and other types of manipulation of the data and the manner in which it is displayed.

In the example, the job seeker is a current lower level designer in the hardware design group. As illustrated in FIG. 7, the job seeker's goals include attaining a position in the hardware testing group.

In a first category of jobs 132, those job positions matching the job seeker's current skills within some additional parameters are identified. In the example, the job positions matching the job seeker's current skills is a lower level position in the hardware testing group and an upper level position in the hardware design group.

In a second category of jobs 134, those job positions matching the requested skills to be acquired at the job position are identified. In the example, the job positions matching the job seeker's skills to be acquired are an upper level designer position and the lower level designer position also identified in the first category of jobs 132. As the example shows, a job position may match the job seeker's current skills and require on-the-job training to acquire those skills the jobs seeker hopes to acquire in a new position.

In a third category of jobs 136, those job positions matching the job seeker's current goals are identified. In the example, the job position matching the job seeker's goals is a manager position. The job position is not one that the job seeker is currently qualified to obtain. Therefore, a category of resources 138 indicates those resources available for acquiring the remaining skills required for the job. In the example, the job seeker should first work to attain an upper level designer position. In addition, the job seeker needs and MBA and certification in software B to qualify for the job position. The category of resources 138 provides the information needed for the job seeker to find programs that qualify for reimbursement by the company and will provide the training in the skills needed. Advantageously, if an employee takes advantage of a company-funded resource, the company may track open job positions the employee will qualify for with the skills attained from the resource.

It should be noted that the job positions displayed may or may not be job positions currently available. In particular, a current employee of a company may enter job criteria and search for job positions meeting that criteria, including job positions that are not currently open, such that that the current employee may obtain the resources necessary to advance within the company when a position is open. Further, by entering job criteria, a current employee may be notified when a matching position does open. Moreover, an individual who is not an employee of a company, but whose goals include attaining a position in that company, may search for job positions matching the individual's criteria in order to obtain the resources for acquiring the skills necessary to attain a position with the company.

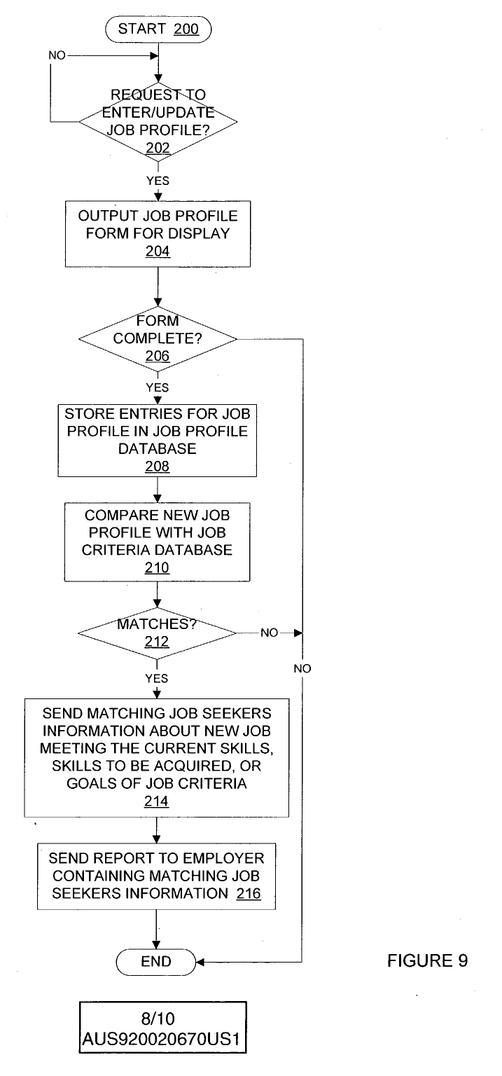

Referring now to FIG. 9, a high level logic flowchart illustrates a process and program for managing a job profile in accordance with the method, system, and program of the present invention. As illustrated, the process starts at block 200 and thereafter proceeds to block 202. Block 202 depicts determining whether a request to enter or update a job profile is received. If a request is not received, then the process iterates at block 202. If a request is received, then the process passes to block 204. Block 204 illustrates controlling output of a job profile form for display at a client system. If a request to update is received, the job profile form preferably includes the information for that job profile retrieved from the job profile database. Next, block 206 depicts determining whether a completed form is returned. If a completed form is not returned but canceled, then the process ends. If a completed form is returned, then the process passes to block 208.

Block 208 illustrates storing the form entries for the job profile in the job profile database. Next, block 210 depicts comparing the new job profile with the entries in the job criteria database. Thereafter, block 212 illustrates determining whether the new job profile matches any of the job criteria in the job criteria database. In particular, the new job profile is compared with job criteria entries to determine if the job profile matches the current skills, skills to be acquired, or goals of any job criteria entries. If there are not any matches, then the process ends. If there are matches, then the process passes to block 214. Block 214 depicts sending the matching job seekers information about the new job profile that meets the current skills, skills to be acquired, or goals of the matching job criteria. Thereafter, block 216 illustrates sending a report to the employer detailing the job criteria entries matching the job profile, and the process ends. Alternatively, a database of job criteria matching that employers job positions may be stored and accessed upon request by the employer.

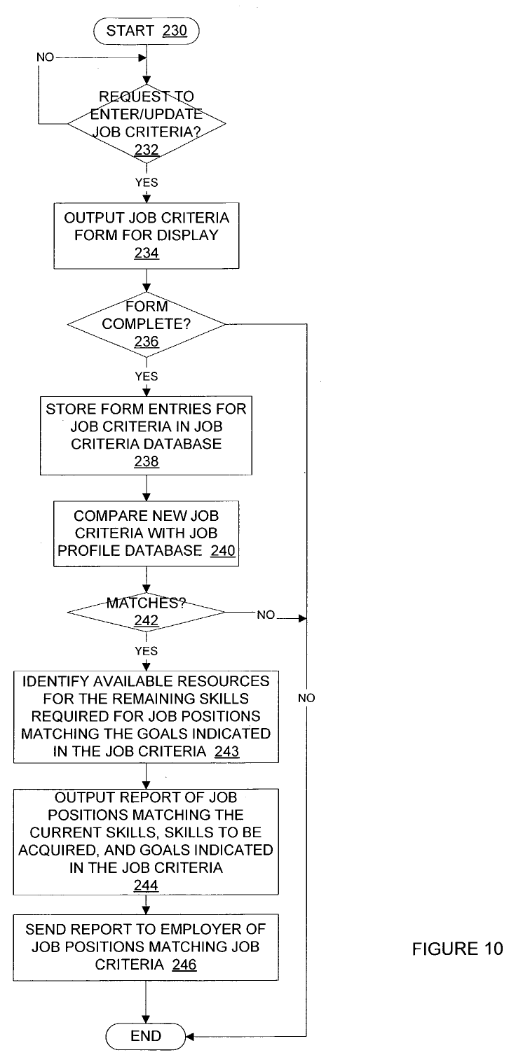

With reference now to FIG. 10, a high level logic flowchart depicts a process and program for managing job criteria in accordance with the method, system, and program of the present invention. As illustrated, the process starts at block 230 and thereafter proceeds to block 232. Block 232 illustrates determining whether a request to enter or update job criteria is received. If a request to enter or update job criteria is not received, then the process iterates at block 232. If a request to enter or update job criteria is received, then the process passes to block 234. Block 234 depicts controlling output of a job criteria form for display at a client system.

Next, block 236 illustrates determining whether a completed form is returned. If a completed form is not returned but canceled, then the process ends. If a completed form is returned, then the process passes to block 238.

Block 238 depicts storing the form entries for job criteria in the job criteria database. Next, block 240 illustrates comparing the new job criteria with the job profile entries in the job profile database. Thereafter, block 242 illustrates determining whether the new job criteria matches any of the job profiles in the job profile database. In particular, the new job criteria is compared with job profile entries to determine if any of the job profile entries match the current skills, skills to be acquired, or goals of the new job criteria. If there are not any matches, then the process ends. If there are matches, then the process passes to block 243. Block 243 illustrates identifying the resources available for the remaining skills required for job positions matching the goals indicated in the job criteria. Next, block 244 depicts controlling output of a report of job positions matching the current skills, skills to be acquired, or goals of the new job criteria.

Thereafter, block 246 illustrates sending a report to the employer detailing of job positions matching the new job criteria, and the process ends. Alternatively, a database of job criteria matching that employers job positions may be stored and accessed upon request by the employer.

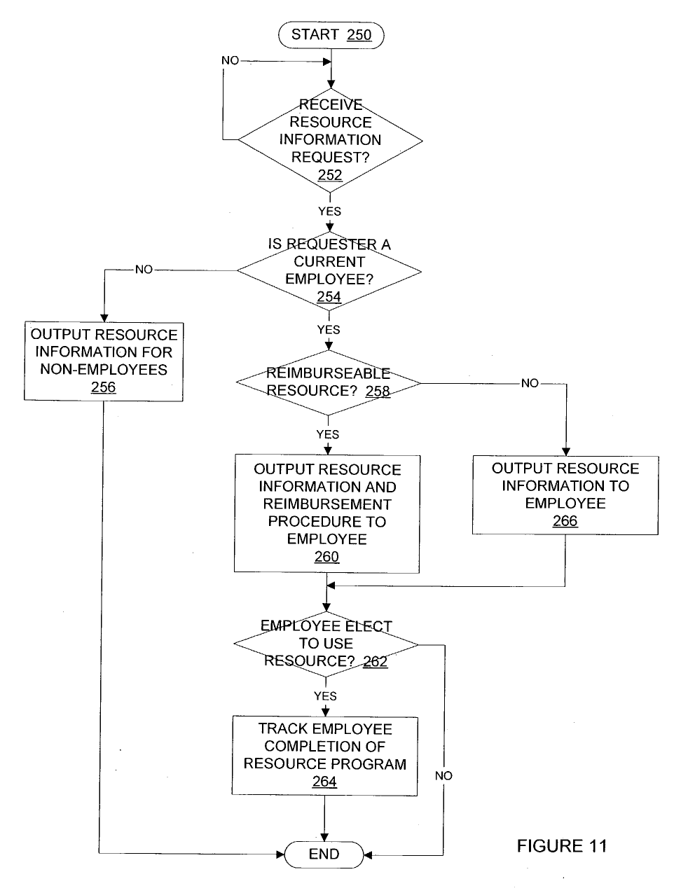

Referring now to FIG. 11, a high level logic flowchart of a process and program for managing resources available to job seekers in accordance with the method, system, and program of the present invention. As depicted, the process starts at block 250 and thereafter proceeds to block 252. Block 252 illustrates determining whether a request for resource information is received. If a request is not received, then the process iterates at block 252. If a request is received, then the process passes to block 254.

Block 254 depicts determining whether the requester is a current employee. If the requester is a current employee, then the process passes to block 258. If the requester is not a current employee, then the process passes to block 256. Block 256 illustrating controlling output of the resource information for non-employees to a client system. The resource information may include selectable links, addresses, data, and other types of information.

Block 258 illustrates determining whether the business will reimburse acquiring the skill provided by the resource. If the business will provide reimbursement, then the process passes to block 260. Block 260 illustrates controlling output of the resource information and reimbursement procedure to the employee, and the process passes to block 262. If the business will not provide reimbursement, then the process passes to block 266. Block 266 illustrates controlling output of the resource information to the employee, and the process passes to block 262.

Block 262 depicts determining whether the employee elects to use the resource. If the employee does not elect to use the resource to acquire a skill, then the process ends. If the employee elects to use the resource to acquire a skill, then the process passes to block 264. Block 264 illustrates tracking the employee completion of the resource program, and the process ends.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular types of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While the invention has been particularly shown and described with reference to a preferred embodiment, it will be understood by those skilled in the art that various changes in form and detail may be made therein without departing from the spirit and scope of the invention.

What is claimed is:

1. A method for facilitating job advancement, comprising:
providing a profile form for a job seeker to enter at least one from among current skills, current goals, and a required skill to be acquired in a new position;
searching a job profile database for at least one job position matching at least one from among said current skills, said current goals, and said required skill to be acquired;
presenting said job seeker with said at least job position matching at least one from among said current skills, said goals, and said required skill to be acquired; and
in response to detecting a remaining skill required for said job seeker to qualify for said at least one job position, providing said job seeker with at least one resource for acquiring said at least one remaining skill.

2. The method for facilitating job advancement according to claim 1, wherein said job seeker is a current employee of a company whose job positions comprise said job profile database.

3. The method for facilitating job advancement according to claim 1, further comprising:
presenting said job seeker with a diagram of a hierarchy of a plurality of job positions within said job profile database, such that said job seeker is provided with an advancement path associated with said particular job position.

4. The method for facilitating job advancement according to claim 1, further comprising:
searching said job profile database for said at least one job position matching only said required skill to be acquired; and
presenting said job seeker with said at least one job position providing for the acquisition of said required skill to be acquired as part of a training program for said at least one job position.

5. The method for facilitating job advancement according to claim 1, further comprising:
tracking whether said job seeker utilizes said at least one resource.

6. The method for facilitating job advancement according to claim 1, further comprising:
providing a profile form for an employer to enter at least one from among skill preferences and goal preferences to be found in a potential employee;
searching a job criteria database for at least one potential employee with job criteria matching a job profile of said employer; and
presenting said employer with said at least one potential employee meeting requirements of said job criteria.

7. A system for facilitating job advancement, comprising:
means for providing a profile form at a data processing system for a job seeker to enter at least one from among current skills, current goals, and a required skill to be acquired in a new position;
means for searching a job profile database for at least one job position matching at least one from among said current skills, said current goals, and said required skill to be acquired;
means for presenting said job seeker with said at least job position matching at least one from among said current skills, said goals, and said required skill to be acquired; and
means, responsive to detecting a remaining skill required for said job seeker to qualify for said at least one job position, for providing said job seeker with at least one resource for acquiring said at least one remaining skill.

8. The system for facilitating job advancement according to claim 7, wherein said job seeker is a current employee of a company whose job positions comprise said job profile database.

9. The system for facilitating job advancement according to claim 7, further comprising:
means for presenting said job seeker with a diagram of a hierarchy of a plurality of job positions within said job profile database, such that said job seeker is provided with an advancement path associated with said particular job position.

10. The system for facilitating job advancement according to claim 7, further comprising:
means for searching said job profile database for said at least one job position matching only said required skill to be acquired; and
means for presenting said job seeker with said at least one job position providing for the acquisition of said required skill to be acquired as part of a training program for said at least one job position.

11. The system for facilitating job advancement according to claim 7, wherein said at least one resource comprises at least one from among an educational resource link, an available job link, a method for reimbursement link, and a organizational resource link.

12. The system for facilitating job advancement according to claim 7, wherein said goals comprise at least one from among a management goal, a certification goal, a salary goal, and an advancement goal.

13. The system for facilitating job advancement according to claim 7, further comprising:
means for tracking whether said job seeker utilizes said at least one resource.

14. The system for facilitating job advancement according to claim 7, further comprising:
means for providing a profile form for an employer to enter at least one from among skill preferences and goal preferences to be found in a potential employee;
means for searching a job criteria database for at least one potential employee with job criteria matching a job profile of said employer; and
means for presenting said employer with said at least one potential employee meeting requirements of said job criteria.

15. A computer program product for facilitating job advancement, comprising:
a recording medium;
means, recorded on said recording medium, for providing a profile form at a data processing system for a job seeker to enter at least one from among current skills, current goals, and a required skill to be acquired in a new position;
means, recorded on said recording medium, for searching a job profile database for at least one job position matching at least one from among said current skills, said current goals, and said required skill to be acquired;
means, recorded on said recording medium, for presenting said job seeker with said at least job position matching at least one from among said current skills, said goals, and said required skill to be acquired; and
means, recorded on said recording medium, for providing said job seeker with at least one resource for acquiring said at least one remaining skill, responsive to detecting a remaining skill required for said job seeker to qualify for said at least one job position.

16. The computer program product for facilitating job advancement according to claim 15, further comprising:
means, recorded on said recording medium, for presenting said job seeker with a diagram of a hierarchy of a plurality of job positions within said job profile database, such that said job seeker is provided with an advancement path associated with said particular job position.

17. The computer program product for facilitating job advancement according to claim 15, further comprising:
means, recorded on said recording medium, for searching said job profile database for said at least one job position matching only said current skills; and
means, recorded on said recording medium, for presenting said job seeker with said at least one job position matching only said current skills.

18. The computer program product for facilitating job advancement according to claim 15, further comprising:
means, recorded on said recording medium, for tracking whether said job seeker utilizes said at least one resource.

19. The computer program product for facilitating job advancement according to claim 15, further comprising:
means, recorded on said recording medium, for providing a profile form for an employer to enter at least one from among skill preferences and goal preferences to be found in a potential employee;
means, recorded on said recording medium, for searching a job criteria database for at least one potential employee with job criteria matching a job profile of said employer; and
means, recorded on said recording medium, for presenting said employer with said at least one potential employee meeting requirements of said job criteria.
